(19) United States
(12) Patent Application Publication
(10) Pub. No.: US 2023/0274223 A1
(43) Pub. Date: Aug. 31, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Toyokazu NAKASHIMA, Nagoya-shi (JP); Shunsuke SAGARA, Nisshin-shi (JP); Naoya OKA, Nagakute-shi (JP)

(21) Appl. No.: 18/149,727

(22) Filed: Jan. 4, 2023

(30) Foreign Application Priority Data
Feb. 28, 2022 (JP) 2022-029293

(51) Int. Cl. G06Q 10/0835; G06Q 30/018

(52) U.S. Cl. CPC G06Q 10/08355; G06Q 30/018

(57) ABSTRACT

The present disclosure relates to an information processing device including a controller configured to execute calculating, based on first information on a travel scheduled route of a vehicle that delivers a package of a user, an emission amount that is an amount of carbon dioxide predicted to be emitted by the vehicle to redeliver the package for each of a plurality of first time zones in which the package is able to be redelivered to the user.

### CROSS-REFERENCE TO RELATED APPLICATION

This application claims priority to Japanese Patent Application No. 2022-029293 filed on Feb. 28, 2022, incorporated herein by reference in its entirety.

### BACKGROUND

### 1. Technical Field

The present disclosure relates to an information processing device, an information processing method, and a storage medium.

### 2. Description of Related Art

Japanese Unexamined Patent Application Publication No. 2011-191828 (JP 2011-191828 A) discloses a label issuing device. The label issuing device disclosed in JP 2011-191828 A issues a label indicating a price of a commodity and a greenhouse gas emission amount of the commodity.

### SUMMARY

The present disclosure is to suppress carbon dioxide emitted by redelivery of a package using a vehicle.

A first aspect of the present disclosure relates to an information processing device including a controller. The controller is configured to execute calculating, based on first information on a travel scheduled route of a vehicle that delivers a package of a user, an emission amount that is an amount of carbon dioxide predicted to be emitted by the vehicle to redeliver the package for each of a plurality of first time zones in which the package is able to be redelivered to the user.

A second aspect of the present disclosure relates to an information processing method execute by a computer. The information processing method includes calculating, based on first information on a travel scheduled route of a vehicle that delivers a package of a user, an emission amount that is an amount of carbon dioxide predicted to be emitted by the vehicle to redeliver the package for each of a plurality of first time zones in which the package is able to be redelivered to the user.

A third aspect of the present disclosure relates to a storage medium that stores a program causing a computer to execute an information processing method. The information processing method includes calculating, based on first information on a travel scheduled route of a vehicle that delivers a package of a user, an emission amount that is an amount of carbon dioxide predicted to be emitted by the vehicle to redeliver the package for each of a plurality of first time zones in which the package is able to be redelivered to the user.

According to the present disclosure, the amount of carbon dioxide emitted by redelivery of the package using the vehicle can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a delivery system;

FIG. 2 is a diagram showing an example of a delivery route of a delivery vehicle;

FIG. 3 is a block diagram schematically showing an example of a functional configuration of a management server;

FIG. 4 is a diagram showing an example of a table configuration of package information held in a package information database;

FIG. 5 is a diagram showing an example of a table configuration of route information held in a route information database;

FIG. 6 is a diagram showing an example of a table configuration of emission amount information held in an emission amount information database;

FIG. 7 is a flowchart of a generation process;

FIG. 8 is a flowchart of a transmission process; and

FIG. 9 is a flowchart of an update process.

### DETAILED DESCRIPTION OF EMBODIMENTS

An information processing device according to a first aspect of the present disclosure is an information processing device that manages delivery of a package by a vehicle. Here, a case will be assumed in which a user requests redelivery of the package. In this case, as a distance of the movement of the vehicle to redeliver the package of the user is longer, an amount of carbon dioxide emitted by the vehicle to the redelivery of the package is larger.

In addition, it is assumed that a point at which the vehicle starts movement to a delivery destination of the package differs depending on a time zone for the redelivery of the package to the user. In this case, a distance of the vehicle to move the delivery destination of the package is changed depending on the time zone for redelivering the package. Therefore, the amount of carbon dioxide emitted by the vehicle to redeliver the package is changed depending on the time zone for redelivering the package.

Accordingly, a controller of the information processing device according to the first aspect of the present disclosure calculates the amount of carbon dioxide (hereinafter, sometimes simply referred to as “emission amount”) predicted to be emitted by the vehicle to redeliver the package based on first information on a travel scheduled route of the vehicle. Here, the controller of the information processing device calculates the emission amount for each of a plurality of first time zones in which the package can be redelivered to the user. As a result, it is possible to grasp the emission amount for each of the first time zones. Then, it is possible to grasp a suitable time zone for the redelivery of the package. As a result, it is possible to suppress the amount of carbon dioxide emitted by the redelivery of the package using the vehicle.

In the following, a specific embodiment of the present disclosure will be described based on the drawings. Unless otherwise specified, the dimensions, materials, shapes, relative dispositions, and the like of the components described in the present embodiment are not intended to limit the technical scope of the present disclosure solely thereto.

### Embodiment

Outline of System

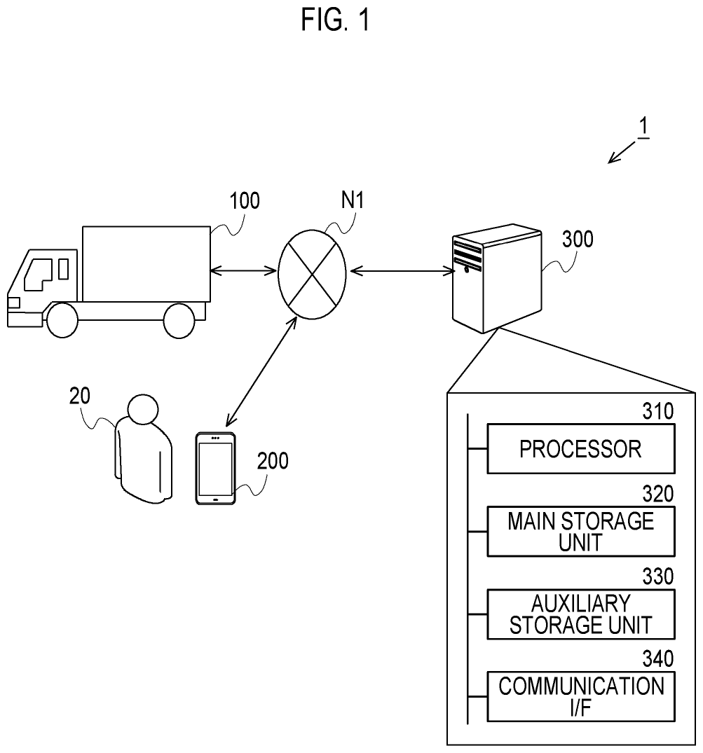

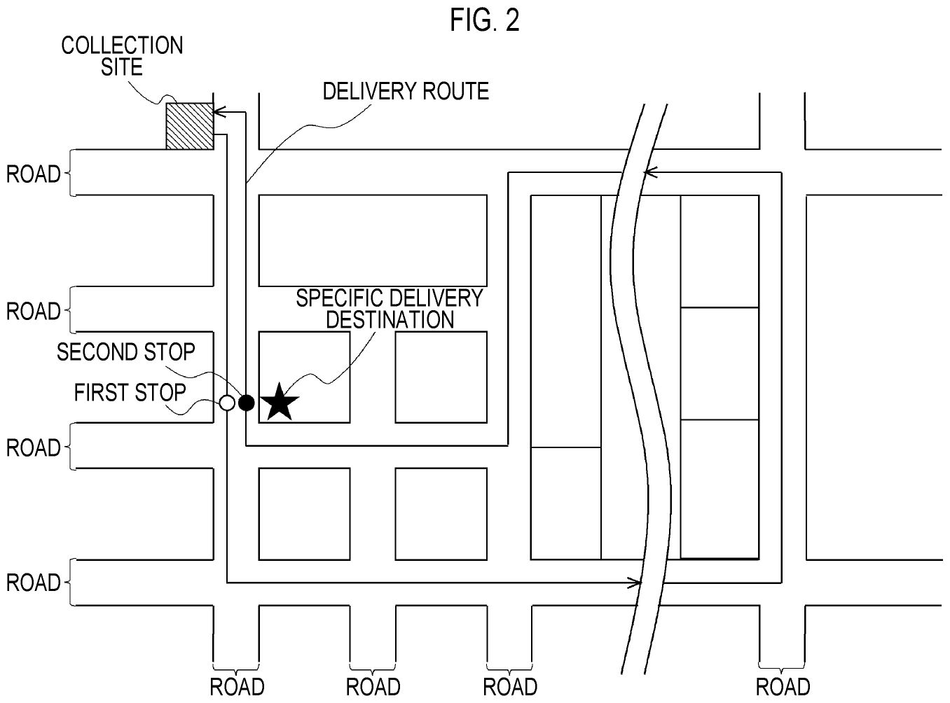

A delivery system 1 according to the present embodiment will be described with reference to FIGS. 1 and 2. FIG. 1 is a diagram showing a schematic configuration of the delivery system 1. The delivery system 1 includes a delivery vehicle 100, a user terminal 200, and a management server 300. In the delivery system 1, the delivery vehicle 100, the user terminal 200, and the management server 300 are connected to each other by a network N1. As the network N1, a wide area network (WAN) that is a worldwide public communication network, such as the Internet, or a telephone communication network, such as a portable phone, may be employed.

Delivery Vehicle

The delivery vehicle 100 is a vehicle that delivers a plurality of packages within a predetermined area. The delivery vehicle 100 includes the package scheduled to be delivered to a user 20. The delivery vehicle 100 carries the packages in accordance with a delivery route decided by the management server 300. Moreover, the delivery vehicle 100 stops at the vicinity of the delivery destination of the package, and an occupant of the delivery vehicle 100 delivers the package directly to the delivery destination, thereby delivering the packages to the respective delivery destinations. The package to be delivered by the delivery vehicle 100 is delivered in a time zone designated for each package. Here, for the package to be delivered by the delivery vehicle 100, any time zone among a plurality of time zones, such as “in the morning”, “from 12:00 p.m. to 2:00 p.m.”, “from 2:00 p.m. to 4:00 p.m.”, or “from 4:00 p.m. to 6:00 p.m.”, is designated. In this case, it may be needed to redeliver the package by the delivery vehicle 100 due to the absence of the delivery destination.

In a case where the delivery of the package is completed, the delivery vehicle 100 transmits completion information indicating the completion of the delivery of the package to the management server 300 via the network N1. In addition, in a case where the delivery destination of the package has been absent, the delivery vehicle 100 transmits absence information indicating that the delivery destination of the package has been absent to the management server 300 via the network N1. The completion information and the absence information are information including an identifier (package ID) for specifying the package. By receiving the completion information or the absence information from the delivery vehicle 100, the management server 300 can grasp a delivery status of the package.

User Terminal

The user terminal 200 is a terminal used by the user 20. The user terminal 200 is a computer or a portable information terminal used by the user 20. Note that the user 20 is a user who has been absent from the delivery destination of the package of the user 20 (hereinafter, sometimes referred to as a “specific delivery destination”). The user 20 recognizes that the delivery destination has been absent when the occupant of the delivery vehicle 100 visits, through a notification slip posted by the occupant of the delivery vehicle 100 to a mailbox or the like at the delivery destination, the notification slip indicating that the delivery destination has been absent. The user 20 requests the management server 300 to arrange for the redelivery of the package by using the user terminal 200. In this case, the user 20 can designate the time zone (hereinafter, sometimes referred to as a “designated time zone”) of the redelivery of the package of the user 20 and request the redelivery of the package of the user 20. The user terminal 200 transmits request information indicating the request for the redelivery of the package to the management server 300 via the network N1. Here, the request information includes the package ID and the designated time zone.

Management Server

The management server 300 is a server that manages the delivery of the package by the delivery vehicle 100. The management server 300 decides the delivery route for the delivery of the package by the delivery vehicle 100. In addition, the management server 300 can change the delivery route based on the request information received from the user terminal 200 such that the package of the user 20 can be redelivered in the designated time zone. In this case, in order for the delivery vehicle 100 to redeliver the package of the user 20 in the designated time zone, the management server 300 sometimes changes the delivery route to deliver the package to the specific delivery destination from a point at which the delivery of the package different from the package of the user 20 is executed.

Here, a case is assumed in which a point at which the delivery vehicle 100 starts movement to the specific delivery destination differs depending on the designated time zone. In this case, the distance of the delivery vehicle 100 to move to the specific delivery destination is changed depending on the designated time zone. As the distance of the movement of the delivery vehicle 100 is longer, the amount of carbon dioxide (hereinafter, sometimes referred to as the “emission amount”) predicted to be emitted by the delivery vehicle 100 to redeliver the package of the user 20 is larger. Therefore, it is assumed that the emission amount is changed depending on the designated time zone.

Accordingly, the management server 300 calculates the emission amount for each of a plurality of time zones in which the package of the user 20 can be redelivered (hereinafter, sometimes referred to as a plurality of “available time zones”) based on the delivery route of the delivery vehicle 100. Moreover, the user 20 uses the user terminal 200 to access the management server 300 via the network N1, thereby designating the designated time zone while referring to the emission amount for each of the available time zones.

FIG. 2 is a diagram showing an example of the delivery route of the delivery vehicle 100. In FIG. 2, a specific delivery destination is indicated by a star mark. In the example shown in FIG. 2, the delivery vehicle 100 delivers the packages using the route indicated by the arrows shown in FIG. 2 as the delivery route. The delivery vehicle 100 travels along the delivery route to depart from a collection site, moves along the arrows shown in FIG. 2, delivers the packages, and returns to the collection site. In addition, in the example shown in FIG. 2, a part of the delivery route is omitted by a wavy line.

After the delivery vehicle 100 departs from the collection site, the delivery vehicle 100 stops once at a point indicated by a white circle shown in FIG. 2, and the occupant of the delivery vehicle 100 visits the specific delivery destination to execute the delivery to the user 20. Note that, in the example shown in FIG. 2, an example is shown in which the user 20 has been absent from the specific delivery destination when the delivery vehicle 100 stops once at the point indicated by the white circle shown in FIG. 2 and the occupant of the delivery vehicle 100 delivers the package of the user 20 to the specific delivery destination.

As shown in FIG. 2, the delivery route is a route that passes through the vicinity of the specific delivery destination twice. Therefore, the emission amount can be minimized by redelivering the package of the user 20 when the delivery vehicle 100 travels in the vicinity of the specific delivery destination for the second time. Accordingly, in the example shown in FIG. 2, the delivery vehicle 100 stops once at a point indicated by a black circle mark shown in FIG. 2, and the package of the user 20 is redelivered. The management server 300 decides a time zone including a time when the delivery vehicle 100 is scheduled to travel through the point indicated by the black circle mark shown in FIG. 2 as a time zone recommended to the user 20 for the redelivery of the package (hereinafter, sometimes referred to as a “recommended time zone”). Note that details of a method of calculating the emission amount for each of the available time zones based on the delivery route of the delivery vehicle 100 by the management server 300 and a method of deciding the recommended time zone will be described below.

The management server 300 includes a computer including a processor 310, a main storage unit 320, an auxiliary storage unit 330, and a communication interface (communication I/F) 340. The processor 310 is, for example, a central processing unit (CPU) or a digital signal processor (DSP). The main storage unit 320 is, for example, a random access memory (RAM). The auxiliary storage unit 330 is, for example, a read only memory (ROM). In addition, the auxiliary storage unit 330 is, for example, a hard disk drive (HDD) or a disk recording medium, such as a CD-ROM, a DVD disk, or a Blu-ray disk. In addition, the auxiliary storage unit 330 may be a removable medium (portable storage medium). Here, examples of the removable medium include a USB memory or an SD card. The communication I/F 340 is, for example, a local area network (LAN) interface board or a wireless communication circuit for wireless communication.

In the management server 300, an operating system (OS), various programs, various information tables, and the like are stored in the auxiliary storage unit 330. In addition, in the management server 300, the processor 310 can realize various functions as described below by loading the programs stored in the auxiliary storage unit 330 into the main storage unit 320 and executing the programs. Note that a part or all of the functions in the management server 300 may be realized by a hardware circuit, such as an ASIC or an FPGA. Note that the management server 300 does not always have to be realized by a single physical configuration, and may be configured by a plurality of the computers linked to each other.

Functional Configuration

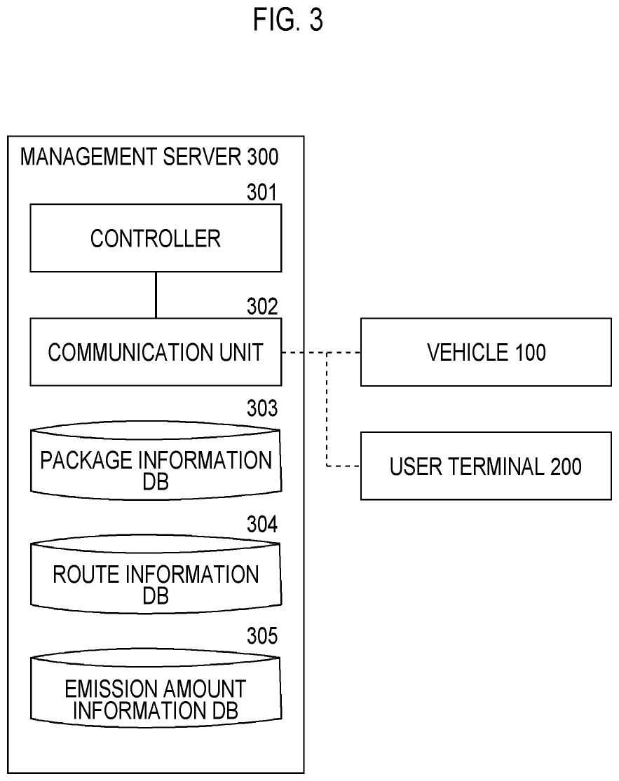

Next, a functional configuration of the management server 300 that configures the delivery system 1 will be described with reference to FIGS. 3 to 6. FIG. 3 is a block diagram schematically showing an example of the functional configuration of the management server 300. The management server 300 includes a controller 301, a communication unit 302, a package information database 303 (package information DB 303), a route information database 304 (route information DB 304), and an emission amount information database 305 (emission amount information DB 305).

The controller 301 has a function of executing arithmetic processing for controlling the management server 300. The controller 301 can be realized by the processor 310 in the management server 300. The communication unit 302 has a function of connecting the management server 300 to the network N1. The communication unit 302 can be realized by the communication I/F 340 in the management server 300.

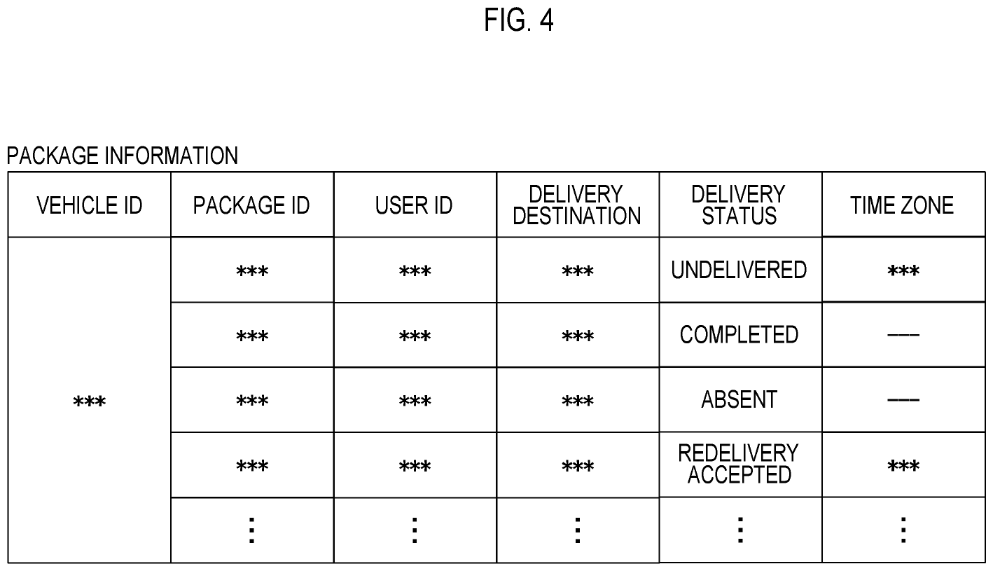

The package information DB 303 has a function of holding package information. The package information is information on the package to be delivered by the delivery vehicle 100. The package information DB 303 can be realized by the auxiliary storage unit 330 in the management server 300. The package information is generated by inputting the information on the package to the management server 300 when an administrator or the like of the management server 300 allocates the packages to the delivery vehicle 100. FIG. 4 is a diagram showing an example of a table configuration of the package information held in the package information DB 303. As shown in FIG. 4, as the package information, a vehicle ID field, a package ID field, a user ID field, a delivery destination field, a delivery status field, and a time zone field are input.

An identifier (vehicle ID) for specifying the delivery vehicle 100 is input to the vehicle ID field. Here, in a case where the management server 300 manages the delivery of the packages by a plurality of delivery vehicles 100, the vehicle IDs corresponding to the delivery vehicles 100 may be input to the vehicle ID field. An identifier (package ID) for specifying the package to be delivered by the delivery vehicle 100 is input to the package ID field. An identifier (user ID) for specifying a recipient of the package corresponding to the package ID input to the package ID field is input to the user ID field. Information on the delivery destination of the package corresponding to the package ID input to the package ID field is input to the delivery destination field. For example, an address of the delivery destination of the package is input to the delivery destination field. In addition, for example, latitude and longitude may be input to the delivery destination field.

Information on the delivery status of the package corresponding to the package ID input to the package ID field is input to the delivery status field. In the delivery status field, “undelivered”, “completed”, “absent”, or “redelivery accepted” is input in accordance with the delivery status of the package. In the delivery status field of the package for which the occupant of the delivery vehicle 100 has not visited the delivery destination even once for the delivery of the package, “undelivered” is input. The controller 301 receives the completion information from the delivery vehicle 100 via the communication unit 302. The controller 301 specifies the package for which the delivery is completed based on the package ID included in the completion information. Moreover, the controller 301 changes the delivery status field corresponding to the specified package from “undelivered” to “completed”.

In addition, the controller 301 receives the absence information from the delivery vehicle 100 via the communication unit 302. Based on the package ID included in the absence information, the controller 301 specifies the package for which the delivery destination has been absent. Moreover, the controller 301 changes the delivery status field corresponding to the specified package from “undelivered” to “absent”.

In addition, the controller 301 receives the request information from the user terminal 200 via the communication unit 302. Based on the package ID included in the request information, the controller 301 specifies the package for which the redelivery is requested. Here, the package specified by the controller 301 is the package for which the delivery destination has been absent at least once. Therefore, “absent” is input to the delivery status field corresponding to the specified package. The controller 301 changes the delivery status field corresponding to the specified package from “absent” to “redelivery accepted”.

A time zone in which the delivery of each package input to the package ID is scheduled (hereinafter, sometimes referred to as “scheduled time zone”) or the designated time zone is input to the time zone field. Here, in a case where the delivery status of the package corresponding to the package ID input to the package ID field is “undelivered”, the scheduled time zone is input to the time zone field. The scheduled time zone is a time zone in which the package is scheduled to be delivered, the time zone being designated by a sender of the package. In addition, in a case where the delivery status of the package corresponding to the package ID input to the package ID field is “redelivery accepted”, the designated time zone included in the request information is input to the time zone field.

In addition, in a case where the delivery status of the package corresponding to the package ID input to the package ID field is “completed”, the delivery of the package is completed, so that the time zone field is blank. In addition, in a case where the delivery status of the package corresponding to the package ID input to the package ID field is “absent”, the redelivery time zone is not designated, so that the time zone field is blank.

The controller 301 can manage the delivery of the package delivered by the delivery vehicle 100 by acquiring the package information held in the package information DB 303. In addition, the controller 301 decides the delivery route of the delivery vehicle 100 based on the package information held in the package information DB 303.

Specifically, the controller 301 specifies the package for which the delivery status field in the package information held in the package information DB 303 is “undelivered” or “redelivery accepted”. Moreover, the controller 301 decides the delivery route of the delivery vehicle 100 based on the specified delivery destination of the package, and the scheduled time zone or designated time zone thereof. The controller 301 decides the delivery route in a case where the package information is updated. As a result, the controller 301 can decide the delivery route such that each package can be delivered by the delivery vehicle 100 in the scheduled time zone or the designated time zone.

In addition, the controller 301 can determine whether or not the delivery of the package is delayed based on the package information held in the package information DB 303. In a case where the delivery of the package by the delivery vehicle 100 is delayed, the controller 301 decides the delivery route of the delivery vehicle 100 based on the specified delivery destination of the package, and the scheduled time zone or designated time zone thereof. Therefore, even in a case where the delivery of the package by the delivery vehicle 100 is delayed, the delivery route can be decided such that each package can be delivered by the delivery vehicle 100 in the scheduled time zone or the designated time zone.

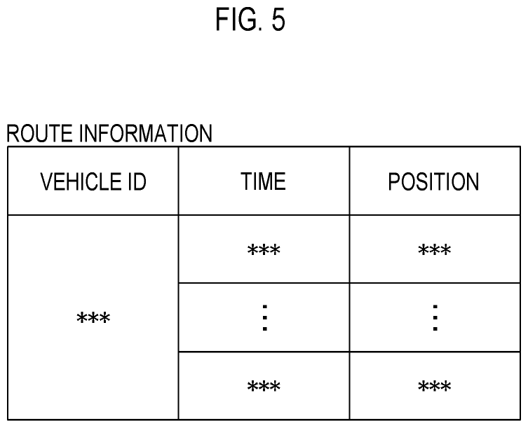

The route information DB 304 has a function of holding the route information. The route information is information on the delivery route of the delivery vehicle 100. The controller 301 generates the route information based on the decided delivery route and stores the generated route information in the route information DB 304. The route information DB 304 can be realized by the auxiliary storage unit 330 in the management server 300. FIG. 5 is a diagram showing an example of a table configuration of the route information held in the route information DB 304.

As shown in FIG. 5, the route information includes the vehicle ID field, a time field, and a position field. The vehicle ID for specifying the delivery vehicle 100 is input to the vehicle ID field. Each time zone from when the delivery vehicle 100 departs from the collection site to when the delivery vehicle 100 returns to the collection site is input to the time field. A position at which the delivery vehicle 100 is scheduled to be present at the time input to the time field is input to the position field. For example, a position at which the delivery vehicle 100 is scheduled to be present at each time is input to the position field by latitude and longitude.

Based on the package information held in the package information DB 303 and the route information held in the route information DB 304, the controller 301 calculates the emission amount in a case where the package of the user 20 is redelivered, for each of the available time zones. Specifically, the controller 301 calculates a temporary delivery route by assuming that the delivery status field in the package information held in the package information DB 303 is changed to “redelivery accepted” and that each available time zone is designated as the designated time zone. Based on the route information held in the route information DB 304, the controller 301 calculates a difference in a travel distance between the delivery route and the calculated temporary delivery route. As described above, the controller 301 can calculate the travel distance that the delivery vehicle 100 is predicted to move to redeliver the package of the user 20 in each available time zone.

Moreover, the controller 301 multiplies the calculated difference in the travel distance by the emission amount of carbon dioxide per unit distance by the delivery vehicle 100 to calculate the emission amount predicted in a case where the package of the user 20 is redelivered in each available time zone. In addition, the controller 301 decides, as the recommended time zone, the available time zone in which the emission amount is predicted to be minimized among the emission amounts predicted for the available time zones.

Note that, in the present embodiment, the controller 301 decides the available time zone in which the emission amount is predicted to be minimized as the recommended time zone. However, the controller 301 does not always have to decide the available time zone in which the emission amount is predicted to be minimized as the recommended time zone. For example, the controller 301 may decide, as a plurality of recommended time zones, a predetermined number of the available time zones in which the emission amount is smaller than other available time zones, among the available time zones. In addition, the controller 301 may decide the time zones including the available time zone in which the emission amount is minimized as the recommended time zones. As a result, even in a case where the delivery of the package by the delivery vehicle 100 is delayed or the package is delivered ahead of schedule, the package can be delivered in the recommended time zone designated by the user 20.

The controller 301 generates the emission amount information based on the emission amount predicted in a case where the delivery vehicle 100 travels on the temporary delivery route for each of the available time zones. The controller 301 stores the generated emission amount information in the emission amount information DB 305. The emission amount information DB 305 has a function of holding the emission amount information. The emission amount information is information on the emission amount predicted for each of the available time zones. The emission amount information DB 305 can be realized by the auxiliary storage unit 330 in the management server 300.

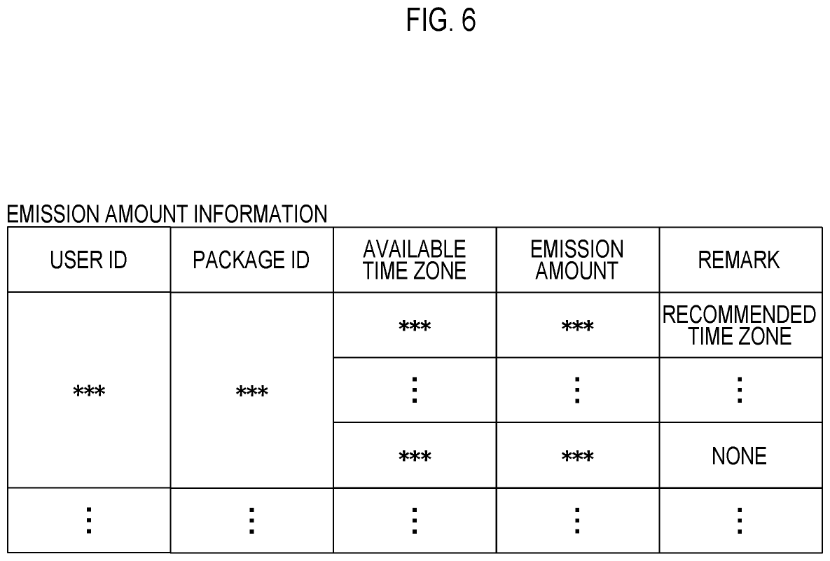

FIG. 6 is a diagram showing an example of a table configuration of the emission amount information held in the emission amount information DB 305. As shown in FIG. 6, the emission amount information includes the user ID field, the package ID field, an available time zone field, an emission amount field, and a remark field. The user ID of the recipient of the package who has been absent when the occupant of the delivery vehicle 100 visits is input to the user ID field. The package ID for specifying the package of the recipient corresponding to the user ID input to the user ID field is input to the package ID field. Each available time zone is input to the available time zone field. The emission amount predicted in a case where the package of the user 20 is redelivered in each available time zone is input to the emission amount field. In a case where the available time zone input to the available time zone field is the recommended time zone, “recommended time zone” is input to the remark field. In addition, in a case where the available time zone input to the available time zone field is not the recommended time zone, “none” is input to the remark field.

The controller 301 generates information (hereinafter, sometimes referred to as “redelivery information”) on the emission amount for each of the available time zones based on the emission amount information held in the emission amount information DB 305. Specifically, in a case where the user 20 uses the user terminal 200 to access the management server 300 for the redelivery of the package of the user 20, the controller 301 generates the redelivery information and transmits the generated redelivery information to the user terminal 200. As a result, the user 20 can decide the designated time zone based on the emission amount for each of the available time zones. In addition, information displayed on a screen of the user terminal 200 when the user 20 requests the redelivery of the package includes information proposing to the user 20 to request the redelivery of the package in the recommended time zone. As a result, it is possible to prompt the user 20 to request the redelivery of the package in the recommended time zone.

Generation Process

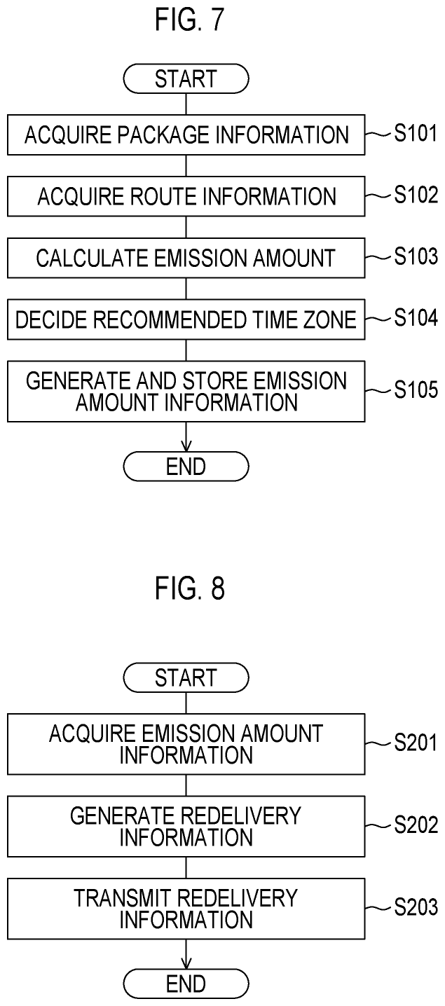

A generation process executed by the controller 301 in the management server 300 in the delivery system 1 will be described with reference to FIG. 7. FIG. 7 is a flowchart of the generation process. The generation process is a process of generating the emission amount information. The execution of the generation process is started in a case where the user 20 accesses the management server 300 using the user terminal 200 for the redelivery of the package.

In the generation process, in S101, the package information is acquired from the package information DB 303. In addition, in S102, the route information is acquired from the route information DB 304. Next, in S103, the emission amount for each available time zone is calculated based on the package information and the route information. Next, in S104, among the calculated emission amounts for the available time zones, the available time zone in which the emission amount is the minimum is decided as the recommended time zone. Next, in S105, the emission amount information is generated and stored in the emission amount information DB 305. Moreover, the generation process ends.

Transmission Process

Next, a transmission process executed by the controller 301 in the management server 300 in the delivery system 1 will be described based on FIG. 8. FIG. 8 is a flowchart of the transmission process. The transmission process is a process of transmitting the redelivery information. The execution of the transmission process is started in a case where the user 20 uses the user terminal 200 to access the management server 300 for the redelivery of the package of the user 20.

In the transmission process, first, in S201, the emission amount information is acquired from the emission amount information DB 305. Next, in S202, the redelivery information is generated based on the acquired emission amount information. Next, in S203, the redelivery information is transmitted to the user terminal 200. Moreover, the transmission process ends.

Update Process

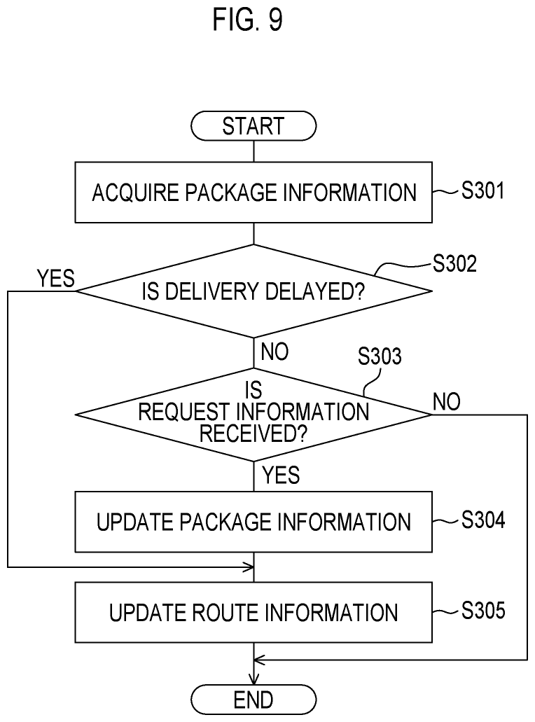

Next, an update process executed by the controller 301 in the management server 300 in the delivery system 1 will be described based on FIG. 9. FIG. 9 is a flowchart of the update process. The update process is a process of updating the route information.

The update process is periodically executed at predetermined intervals.

In the update process, first, in S301, the package information held in the package information DB 303 is acquired. Next, in S302, the controller 301 determines whether or not the delivery is delayed based on the package information. In a case where a positive determination is made in S302, the delivery route needs to be changed. Accordingly, in S305, the route information is updated. Specifically, based on the package information held in the package information DB 303, a new delivery route is decided and the route information is updated.

In addition, in a case where a negative determination is made in S302, in S303, a determination is made as to whether or not the request information is received. In a case where a negative determination in S303 is made, the delivery route does not have to be changed. Accordingly, the execution of the update process ends once. In a case where a positive determination is made in S303, the package information is updated in S304. Specifically, based on the package ID included in the request information, the delivery status field in the package information is updated from “absent” to “redelivery accepted”. In addition, based on the package ID included in the request information and the designated time zone, the designated time zone is input to the time zone field in the package ID field. Next, the process of S305 is executed. In this case, the process of S305 is executed based on the package information updated in S304. Moreover, the update process ends once.

Here, another user different from the user 20 who accesses the management server 300 (hereinafter, sometimes referred to as “the other user”) may request the redelivery of the package before the user 20 requests the redelivery. In this case, the delivery route may be changed by the other user who requests the redelivery of the package. In addition, the delivery route may be changed due to the delay in the delivery of the package. However, since the delivery route is appropriately changed by the update process, the management server 300 can calculate the emission amount for the request for the redelivery of the package by the user 20 based on the changed delivery route.

As described above, the delivery system 1 calculates the emission amount for each of the available time zones. As a result, the user 20 can grasp the amount of carbon dioxide emitted by requesting the redelivery of the package. In addition, by transmitting the redelivery information from the delivery system 1, it is possible to prompt the selection of the designated time zone as the recommended time zone. As described above, by using the delivery vehicle 100, it is possible to suppress carbon dioxide emitted by the redelivery of the package.

### Modification Example 1

Note that, in the present embodiment, even in a case where the route information includes the delivery route of the delivery vehicle 100 after a date on which the user 20 cannot accept the package (hereinafter, may be referred to as an “absence date”). In addition, in this case, the available time zones may include a time zone in which the package of the user 20 can be redelivered after the absence date. In this case, the administrator of the management server 300 updates the package information at a point in time when the package to be delivered by the delivery vehicle 100 after the absence date is decided. The package to be delivered by the delivery vehicle 100 after the date (absence date) on which the scheduled time zone of the package of the user 20 is included is decided in, for example, a predetermined time of a date including the scheduled time zone of the package of the user 20. Then, the management server 300 decides the delivery route of the delivery vehicle 100 based on the delivery destination of the package delivered by the delivery vehicle 100 after the date including the scheduled time zone of the package of the user 20, and the scheduled time zone or the designated time zone.

Based on the package information including the information on package scheduled to be delivered after the absence date and the route information including the delivery route after the absence date, the management server 300 calculates the emission amount for each of the available time zones after the absence date. As a result, it is possible to compare the emission amount in a case where the package is redelivered on the absence date with the emission amount in a case where the package is redelivered after the absence date. As a result, in a case where the redelivery of the package after the absence date results in a smaller emission amount, it is possible to select the available time zone after the absence date as the designated time zone. In addition, the management server 300 can decide the recommended time zone from among the available time zones on the absence date and the available time zones after the absence date. Even in this way, it is possible to suppress the amount of carbon dioxide emitted by the redelivery of the package using the delivery vehicle 100.

### Modification Example 2

In the present embodiment, the management server 300 transmits the redelivery information to the user terminal 200 based on the emission amount information. However, the management server 300 does not always have to transmit the redelivery information to user terminal 200. Since the management server 300 calculates the emission amount for each of the available time zones, an employee or the like related to the management server 300 can grasp the emission amount for each of the available time zones. Accordingly, it is possible for the employee or the like related to the management server 300 to propose the request for the redelivery of the package in the recommended time zone in response to an inquiry from the user 20. Note that the management server 300 may automatically transmit the information proposing the request for the redelivery of the package in the recommended time zone to the user terminal 200 based on the calculated emission amount for each of the available time zones. As a result, the user 20 is prompted to request the redelivery of the package in the recommended time zone. Even in this way, it is possible to suppress the amount of carbon dioxide emitted by the redelivery of the package using the delivery vehicle 100.

### Other Embodiments

The embodiment described above is merely an example, and the present disclosure can be carried out with appropriate changes within a range not departing from the gist of the present disclosure. In addition, the process and means described in the present disclosure can be freely combined and carried out as long as no technical inconsistency occurs.

In addition, the process executed by one device in the description may be allocated and executed by a plurality of devices. Alternatively, the process executed by different devices in the description may be executed by one device. In a computer system, a hardware configuration (server configuration) that realizes each function can be flexibly changed.

The present disclosure can also be realized by supplying a computer program that implements the functions described in the above embodiment to a computer, and reading out and executing the program by one or more processors provided in the computer. Such a computer program may be provided to the computer by a non-transitory computer-readable storage medium that can be connected to a system bus of the computer, or may be provided to the computer via a network. Examples of the non-transitory computer-readable storage medium include any type of disk, such as a magnetic disk (floppy (registered trademark) disk or hard disk drive (HDD)) or an optical disk (CD-ROM, DVD disk, or Blu-ray disk), a read only memory (ROM), a random access memory (RAM), an EPROM, an EEPROM, a magnetic card, a flash memory, an optical card, and any type of medium suitable for storing an electronic instruction.

What is claimed is:

1. An information processing device comprising a controller configured to execute calculating, based on first information on a travel scheduled route of a vehicle that delivers a package of a user, an emission amount that is an amount of carbon dioxide predicted to be emitted by the vehicle to redeliver the package for each of a plurality of first time zones in which the package is able to be redelivered to the user.

2. The information processing device according to claim 1, wherein the controller is configured to further execute transmitting second information on the emission amount for each of the first time zones to a terminal related to the user.

3. The information processing device according to claim 1, wherein the controller is configured to further execute deciding a second time zone recommended as a time zone for redelivering the package to the user from among the first time zones based on the emission amount predicted for each of the first time zones.

4. The information processing device according to claim 3, wherein the controller is configured to decide a time zone in which the emission amount predicted for each of the first time zones is minimized as the second time zone.

5. The information processing device according to claim 3, wherein second information includes information for proposing to the user to request redelivery of the package in the second time zone.

6. The information processing device according to claim 1, wherein the controller is configured to calculate the emission amount predicted for each of the first time zones based on a distance that the vehicle is predicted to move to redeliver the package in each first time zone.

7. The information processing device according to claim 1, wherein:
the first information includes information on the travel scheduled route of the vehicle after a date on which the user is unable to accept the package;
the first time zones include a time zone in which the package is able to be redelivered to the user after the date on which the user is unable to accept the package; and
the controller is configured to calculate the emission amount for each of the first time zones after the date on which the user is unable to accept the package.

8. The information processing device according to claim 1, wherein the controller is configured to:
further execute updating the first information in a case where the travel scheduled route of the vehicle is changed; and
execute calculating the emission amount based on the updated first information.

9. An information processing method execute by a computer, the information processing method comprising calculating, based on first information on a travel scheduled route of a vehicle that delivers a package of a user, an emission amount that is an amount of carbon dioxide predicted to be emitted by the vehicle to redeliver the package for each of a plurality of first time zones in which the package is able to be redelivered to the user.

10. The information processing method according to claim 9, further comprising transmitting second information on the emission amount for each of the first time zones to a terminal related to the user.

11. The information processing method according to claim 9, further comprising deciding a second time zone recommended as a time zone for redelivering the package to the user from among the first time zones based on the emission amount predicted for each of the first time zones.

12. The information processing method according to claim 11, wherein a time zone in which the emission amount predicted for each of the first time zones is minimized is decided as the second time zone.

13. The information processing method according to claim 11, wherein second information includes information for proposing to the user to request redelivery of the package in the second time zone.

14. The information processing method according to claim 9, wherein the emission amount predicted for each of the first time zones is calculated based on a distance that the vehicle is predicted to be move to redeliver the package in each first time zone.

15. The information processing method according to claim 9, wherein:
the first information includes information on the travel scheduled route of the vehicle after a date on which the user is unable to accept the package;
the first time zones include a time zone in which the package is able to be redelivered to the user after the date on which the user is unable to accept the package; and
in the information processing method, the emission amount is calculated for each of the first time zones after the date on which the user is unable to accept the package.

16. The information processing method according to claim 9, further comprising updating the first information in a case where the travel scheduled route of the vehicle is changed,
wherein the emission amount is calculated based on the updated first information.

17. A non-transitory storage medium that stores a program causing a computer to execute an information processing method comprising calculating, based on first information on a travel scheduled route of a vehicle that delivers a package of a user, an emission amount that is an amount of carbon dioxide predicted to be emitted by the vehicle to redeliver the package for each of a plurality of first time zones in which the package is able to be redelivered to the user.

18. The storage medium according to claim 17, wherein the information processing method further comprises transmitting second information on the emission amount for each of the first time zones to a terminal related to the user.

19. The storage medium according to claim 17, wherein the information processing method further comprises deciding a second time zone recommended as a time zone for redelivering the package to the user from among the first time zones based on the emission amount predicted for each of the first time zones.

20. The storage medium according to claim 19, wherein, in the information processing method, a time zone in which the emission amount predicted for each of the first time zones is minimized is decided as the second time zone.
